(19) United States
(12) Patent Application Publication
(10) Pub. No.: US 2016/0153647 A1
(43) Pub. Date: Jun. 2, 2016

(54) MODULAR HEAT SINK

(71) Applicant: KONINKLIJKE PHILIPS N.V., Eindhoven (NL)

(72) Inventors: Lihua LIN, Shanghai (CN); Huaizhou LIAO, Shanghai (CN)

(21) Appl. No.: 14/900,364

(22) PCT Filed: Jun. 10, 2014
(86) PCT No.: PCT/IB2014/062105

§ 371 Date: Dec. 21, 2015

(30) Foreign Application Priority Data
Jun. 26, 2013 (CN) PCT/CN2013/078045

(51) Int. Cl. F21V 29/71; F21V 29/83; F21V 29/81

(52) U.S. Cl. CPC F21V 29/71; F21V 29/81; F21V 29/83; F21Y 2101/02

(57) ABSTRACT

A modular heat dissipation assembly (2) used for a light emitting device (100) is presented. It comprises a base (22), which comprises a first number of arrangements (23), for thermally coupling to a light source (31) of the light emitting device (100); and a second number of heat conducting elements (21) which are attached to the base (22) via the arrangements (23), and the second number varies from zero to a maximum equal to the first number, so that a thermal capacity of the modular heat dissipation assembly matches a predetermined thermal load of the light emitting device. In one aspect, configurations to maintain a chimney effect with the modular heat dissipation assembly are presented. A luminaire comprising such a heat dissipation assembly and the manufacturing method for the heat dissipation assembly are also presented.

### FIELD OF THE INVENTION

The invention relates to a heat sink for a light emitting device, and more specifically to a heat sink for a LED lamp or luminaire. The invention further relates to a luminaire comprising a LED mounted on such a heat sink.

### BACKGROUND OF THE INVENTION

Usually, a series of LED products includes LED products with varying power consumption from low to high, for example, downlight LED lamp products. Due to the use of a plurality of LEDs in one product or of LEDs with different power levels, each LED lamp needs a different heat sink to solve thermal problems at different levels. In most cases, the heat sinks are manufactured by a die-casting process. For example, a 6-inch downlight LED product series including low and high lumen levels will need at least three types of heat sink. Thus, either product cost or tooling cost is high.

US 2009/0303725A1 discloses a LED heat sink with a LED unit and a pipe. The LED unit has a base with a LED chip attached to the top of the base. The pipe has an inlet end, an outlet end, a body, multiple inlets, multiple partitioning walls and multiple partitions. The inlet end is attached to the base. The inlets are defined near the base. There may be a conducting block between the LED unit and the pipe. In case multiple LED units are used, multiple pipes may be combined on multiple conducting blocks. However, the air cooling effect is limited because the inlets are configured on the side wall of the pipes, and the airflow will become obstructed due to the position of the conducting blocks.

It is desired to have a heat sink with improved heat dissipation together with the advantages of low cost and good manufacturability as compared to the prior art.

### SUMMARY OF THE INVENTION

It is an object of the invention, among others, to achieve a better heat dissipation in comparison with current heat sinks and to provide the advantages of low cost and improved manufacturability.

To better address one or more of these concerns, in an aspect of the invention, a modular heat dissipation assembly used for a light emitting device is presented. It comprises a base, which comprises a first number of arrangements, for thermally coupling to a light source of the light emitting device, and a second number of heat conducting elements. The heat conducting elements are attached to the base, and the second number varies from zero to a maximum equal to the first number, so that a thermal capacity of the modular heat dissipation assembly matches a predetermined thermal load of the light emitting device. The modular heat dissipation assembly is formed with a first aperture, a second aperture opposite to the first aperture, and an air channel through the modular heat dissipation assembly such that, when the modular heat dissipation assembly transfers heat from the light source during operation of the light source so as to create heated air surrounding the modular heat dissipation assembly, ambient air is drawn through the first aperture and the heated air is exhausted through the second aperture, via a chimney effect in response to heat generated by the light source, thereby creating an airflow trajectory in the air channel from the first aperture to the second aperture.

Preferably, the air channel is formed through the arrangements on the base, and/or along a longitudinal axis through each of the heat conducting elements. Further, the longitudinal axis of each heat conducting element attached to the base is configured substantially parallel to a main axis of the light emitting device. The main axis of the light emitting device preferably corresponds to an optical axis of the light emitting device.

It is no longer necessary to produce different types of heat sink with different thermal capacity for one product series. Only two kinds of standardized components, i.e. a base and a heat conducting element, are needed. Users can pick one base and some heat conducting elements to assemble the final heat sink according to the actual thermal load of the light emitting device. If the light emitting device is a high power lamp, the user can take more heat conducting elements to get a high heat dissipation performance. If the light emitting device is a low power lamp, the user will use fewer heat conducting elements or even no heat conducting element at all to save cost. Mass production of merely two kinds of components is also a nice cost-saving solution.

Preferably, the heat conducting elements may comprise pipes. The arrangements comprise holes into which the heat conducting elements can be inserted.

The heat conducting elements may be identical in shape. The arrangements of the base and the heat conducting elements are attached to each other by way of tight-fitting, screwing or soldering, or any other known connecting techniques, which allows a stable connection between the base and the heat conducting elements with good thermal conductivity. The base and the heat conducting elements comprise a thermal conductive material so as to effectively transport and dissipate the heat from the light source.

According to an embodiment of the modular heat dissipation assembly, a central portion of the base is configured for thermally coupling to the light source and/or a driver for the light source, and a rim portion of the base comprises the arrangements. Preferably, the arrangements are evenly distributed on the base. This for instance allows the heat conducting elements to be mounted around the heat source (the light source and/or the driver) so as to realize very efficient cooling of the light emitting device and also a compact size of the light emitting device.

In another aspect of the invention, a luminaire comprising the above mentioned modular heat dissipation assembly is presented, wherein the base is thermally coupled to the light source of the light emitting device. Preferably, the light emitting device comprises a LED or LED array.

In a further aspect of the invention, a method of manufacturing a modular heat dissipation assembly for a light emitting device is presented, including:

providing a plurality of heat conducting elements;

providing a base;

providing arrangements on the base for attaching the heat conducting elements;

determining a thermal load of the light emitting device;

attaching a number of heat conducting elements to the base, wherein the number varies from zero to maximum, so that a thermal capacity of the modular heat dissipation assembly matches the thermal load;

forming the modular heat dissipation assembly with a first aperture, a second aperture and an air channel through the modular heat dissipation assembly such that, when the modular heat dissipation assembly transfers heat from the light source during operation of the light source so as to create heated air surrounding the modular heat dissipation assembly, ambient air is drawn through the first aperture and the heated air is exhausted through the second aperture via a chimney effect in response to heat generated by the light source, thereby creating an airflow trajectory in the air channel from the first aperture to the second aperture.

Preferably, the air channel is formed through the arrangements on the base, and/or along a longitudinal axis through each of the heat conducting elements.

Preferably, the step of attaching a number of heat conducting elements to the base comprises tight-fitting, screwing or soldering, which allows a stable connection between the base and the heat conducting elements and good thermal conductivity.

It is noted that the invention relates to all possible combinations of features recited in the claims.

### BRIEF DESCRIPTION OF THE DRAWINGS

These and other aspects of the modular heat dissipation assembly and the lamp or luminaire with the modular heat dissipation assembly according to the invention will become apparent from and will be elucidated with respect to the implementations and embodiments described hereinafter and with reference to the accompanying drawings, in which

FIG. 1 is a perspective bottom view of a luminaire with an embodiment of a modular heat dissipation assembly according to the present invention;

FIG. 2 is a perspective top view of the luminaire shown in FIG. 1;

FIG. 3 is an exploded view of the luminaire shown in FIG. 1;

FIG. 4 is a perspective top view of a high-power luminaire with another embodiment of a modular heat dissipation assembly;

FIG. 5 is a perspective top view of a low-power luminaire with yet another embodiment of a modular heat dissipation assembly;

FIG. 6 is a perspective top view of a minimum-power luminaire with a further embodiment of a modular heat dissipation assembly; and

FIG. 7 is a flow chart of a method of manufacturing a modular heat dissipation assembly according to the present invention.

### DETAILED DESCRIPTION

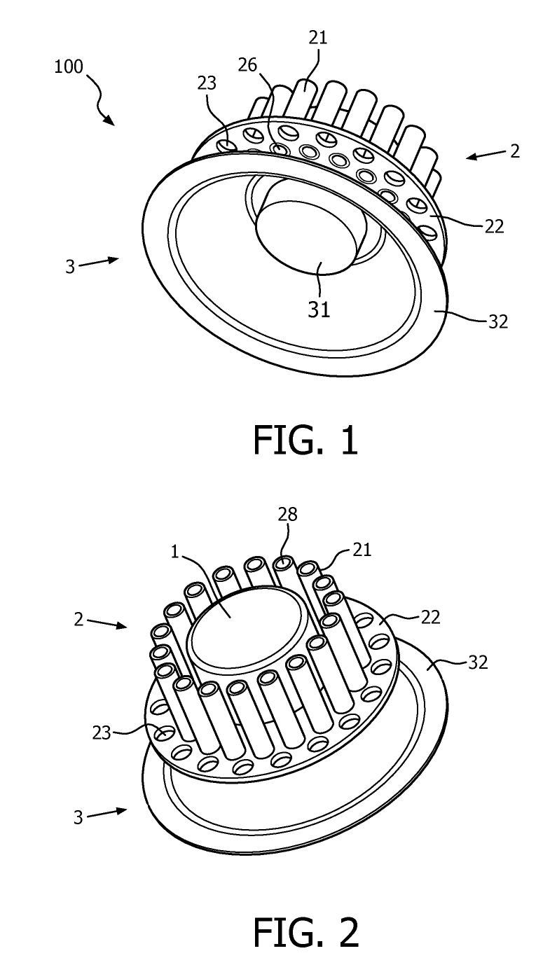

An embodiment of a heat sink module according to the present inventive concept is illustrated in FIGS. 1, 2 and 3. As shown, a lamp 100 consists of a power supply module 1, a heat sink module 2, and an optical module 3. The optical module 3 comprises a light source 31, a reflector 32 and retention components (not shown in the Figures), such as screws, to hold the reflector in the lamp. The light source 31 is for example a LED or an array of LEDs.

The heat sink module 2 comprises a base 22 (in this embodiment formed as a heat spreader 22), and heat conducting elements 21 (in this embodiment formed as pipes 21). The light source 31 and/or the power supply module 1 are thermally coupled to a central portion of the heat spreader 22. Holes 23 are provided in the rim portion of the heat spreader 22, which allow attaching the pipes 21 to the heat spreader 22. The holes 23 may be screw-threaded for firmly attaching the pipes 21 to the heat spreader 22. The holes 23 may also simply be configured to form a tight fit with the pipes 21. Alternatively, the pipes 21 may also be soldered or glued on to the heat spreader 22. It should be understood that, when the holes 23 are screw threaded, the pipes 21 also have a corresponding screw thread. The pipes shown in the figures are hollow and cylindrical. It should be understood that the pipes can be in other suitable shapes, such as square in sectional view, as long as there is an air channel therethrough. Heat generated by the light source 31 and/or the power supply module 1 is transported via the heat spreader 22 to the pipes 21 which act as heat sink fins. Then, the heat is dissipated together with the air around the heat sink fins, especially through the air channel formed within the pipes, because of the “chimney effect”.

In this embodiment, the holes 23 in the heat spreader 22 may have an identical structure, and each of the pipes 21 may also be identical in shape. For example, the holes can be drilled to the same shape by the same tooling, and the pipes can be cut from one long section of tube. Therefore, these two components can be mass-produced as standardized elements at very low cost. With such standardization approach, the same components can be used for different products, so that the cost can be further reduced.

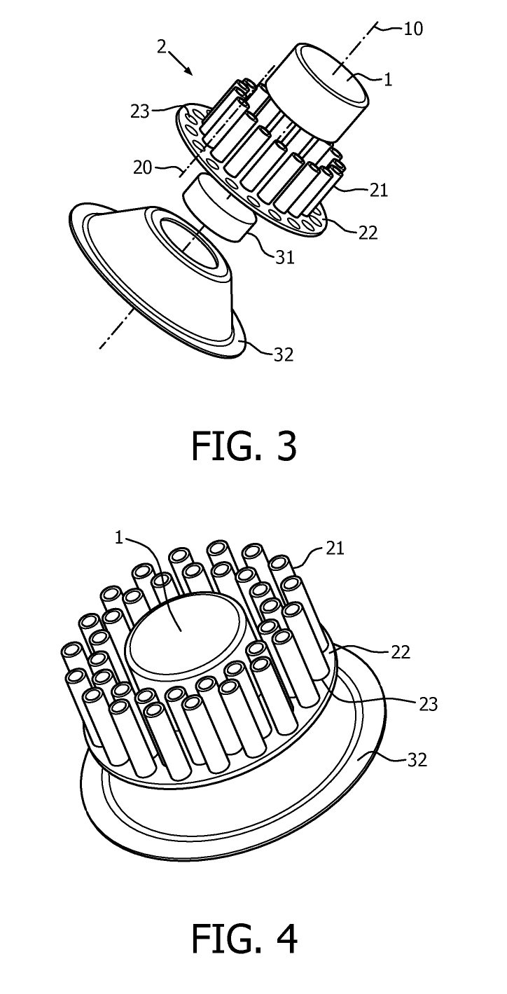

As shown in FIG. 3, after assembly, the axis 20 of the pipes may be parallel to the axis 10 of the lamp. The hollow pipes 21, acting as air channels, allow air to flow through, entering the pipe at one end and leaving the pipe at the other end. A convection airflow transports heat from the outer and inner side surface of the pipes. In this way, especially when the lamp is used as a downlight, ambient air can be drawn into the air channel, because of the chimney effect, and flow from the front to the rear side of the lamp without any obstacle. Therefore, the cooling effect is improved considerably compared to the prior art heat sinks.

In the above embodiment, the pipes have a cylindrical tubular shape. However, in other embodiments, the pipes 21 (the heat conducting elements) may have other shapes, such as a square tubular shape, or tubes with special sectional shapes, such as triangular, rectangular, elliptical, polygonal, etc. And the pipes are not necessarily identical in diameter along the longitudinal axis, e.g., they may be tapered along the axis, or in the shape of a trumpet. The tapered shape has the additional advantage that it allows easy mounting into the holes. The holes may have a shape corresponding to the shape of the outside of the pipes to allow for easy mounting.

In the above embodiment, the heat spreader 22 is disc-shaped, comprising a central portion for the heat source, and a rim portion for mounting the heat conducting/dissipation elements. In other embodiments, the heat spreader may have different shapes, which are not shown in the figures, for example, rectangular or even asymmetrical shapes. The heat spreader may comprise a main body thermally coupled to the light source, which is a source of heat, and at least a portion for mounting the heat dissipation elements.

As shown in FIGS. 1-3, a predetermined number of pipes 21 are mounted on the heat spreader 22. This solution is suitable for medium-power lamps and can be tailored according to the predetermined thermal load of the lamp or luminaire. The thermal load of the lamp or luminaire may be determined by running a simulation with suitable software or experimental tests. The higher the expected thermal load, the more pipes are attached to the heat spreader. Further, although in many cases the pipes are evenly arranged on the heat spreader, asymmetrical configuration is also practical. For instance, for the lamp or luminaire with an uneven thermal distribution profile, more pipes can be mounted in the hotspot area of the heat spreader, while fewer pipes are mounted on the relatively cool area of the heat spreader.

A high-power lamp is shown in FIG. 4. All holes 23 are coupled to pipes 21. This solution has the highest heat-dissipation capacity, for example, implemented in a lamp with 3,000 lumen light output.

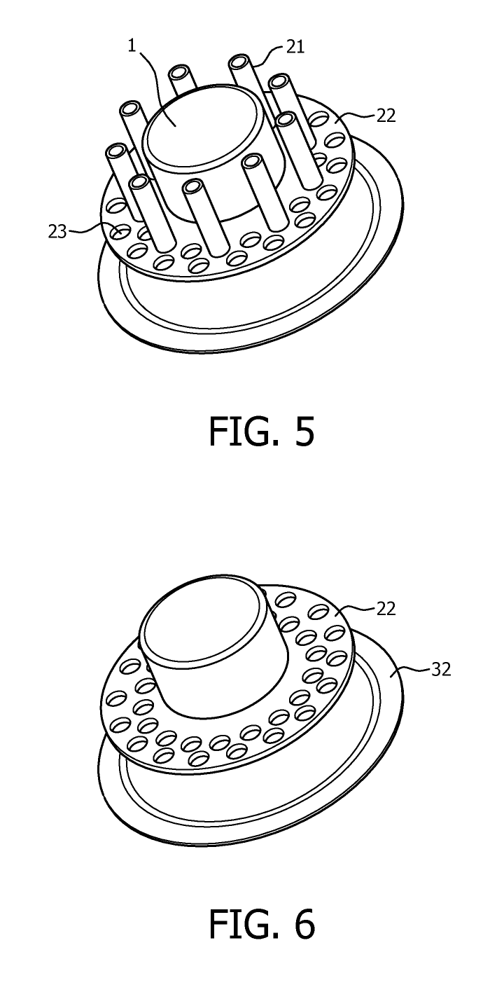

As shown in FIG. 5, only a few pipes are mounted, for example 9 pipes, while a maximum of 36 pipes is possible; moreover, they are evenly distributed on the heat spreader. This solution is suitable for low-power lamps, for example, a lamp with 1000 lumen light output, because the thermal load of the light source produces an amount of heat that can be dissipated/transported by the heat spreader and such a number of pipes.

For lamps with a very small heat load, the heat spreader 22 alone can be used without any pipe 21, as shown in FIG. 6, for example, a lamp with 800 lumen output, because the thermal load of the light source produces an amount of heat that can be dissipated/transported by the heat spreader 22 alone.

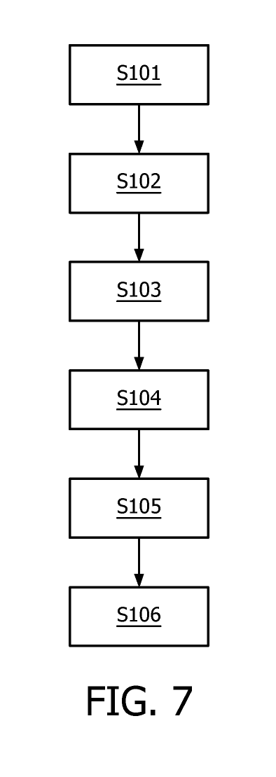

As shown in FIG. 7, a method is presented for manufacturing a modular heat dissipation assembly according to the present invention:

In step S101, metal pipes 21 are produced, which are preferably identical in shape. The simplest way is to cut a long metal tube into pieces of the same length. Of course, the pipe-shaped heat conducting elements can be produced by means of other known techniques, such as molding or die casting.

In step S102, a heat spreader 22 is produced. The plate-shaped heat spreader 22 can be produced by punching or blanking of metal sheets, or any other known techniques.

In step S103, holes 23 are formed in the heat spreader 22. The holes 23 are adapted to the outer shape of one end of the pipes 21 for allowing the pipes to be mounted on the heat spreader. For example, the holes can be provided with inner screw thread, while the pipes are produced so as to have a corresponding outer screw thread at one end thereof. Alternatively, the dimensions of the holes and the pipe ends are such that the pipe ends are a tolerance fit in the holes, so that the pipes can be mounted into the holes by tight-fitting, gluing or soldering.

In step S104, a thermal load of the light emitting device is determined for instance by running a simulation with the suitable software or experimental tests.

In step S105, a number of pipes 21 is attached to the heat spreader 22. The number of pipes varies from zero to a maximum with respect to the predetermined thermal load in step S104. The higher the expected thermal load, the greater the number of pipes attached to the heat spreader. This is similar to previous embodiments shown in FIGS. 1-6, and will not be explained in further detail for the sake of brevity only.

The pipes 21 may be attached to the heat spreader 22 via tight-fitting, screwing or soldering, or any other known connecting method, which allows a stable connection between the heat spreader and the pipes with good thermal conductivity, so that the heat from the light source can be conducted from the heat spreader to the pipes, and then dissipated to the surrounding air.

In step S106, the modular heat dissipation assembly is formed with a first aperture (26), a second aperture (28) and an air channel through the modular heat dissipation assembly (through the hollow pipes). In one embodiment, pipes 21 are attached to through holes 23 in the heat spreader 22, the air channels are formed through the pipes between the two ends of each pipe. In other embodiments, the holes 23 are blind holes, or if there are obstructions inside the holes or the pipes due to, for instance, the attaching process S105, the air channel may be formed by drilling through the holes 23 and/or the pipes 21 to remove the obstructions. When the modular heat dissipation assembly transfers heat from the light source during operation of the light source, air surrounding the modular heat dissipation assembly is heated. Ambient air is drawn through the first aperture and the heated air is exhausted through the second aperture by the chimney effect.

The longitudinal axis 20 of each pipe 21 attached to the heat spreader may be configured substantially parallel to a main axis 10 of the light emitting device. The main axis 10 corresponds to an optical axis of the light emitting device. In this way, each pipe has an air channel therethrough along the longitudinal axis 20, such that an airflow is created in the air channel that allows ambient air to be drawn into the air channel by the chimney effect. Further, the heat spreader 22 is not an obstacle for the airflow and the cooling effect is improved considerably.

A person skilled in the art will realize that the present invention by no means is limited to the preferred embodiments described hereinabove. On the contrary, many modifications and variations are possible within the scope of the appended claims. It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word “comprising” does not exclude the presence of elements or steps not listed in a claim. The word “a” or “an” preceding an element does not exclude the presence of a plurality of such elements. The usage of the words first, second and third, etc., does not indicate any ordering. These words are to be interpreted as names. No specific sequence of acts is intended to be required unless specifically indicated.

1. A modular heat dissipation assembly for a light emitting device, comprising:
a base for thermally coupling to a light source of the light emitting device, which base comprises a first number of arrangements; and
a second number of heat conducting elements which are attached to the base via the arrangements, and the second number is less than or equal to the first number, wherein the head conducting elements comprise pipes; wherein
the modular heat dissipation assembly is formed with a first aperture, a second aperture and an air channel through the modular heat dissipation assembly
wherein the arrangements comprise though holes into which the heat conducting elements can be inserted:
wherein the air channel is formed through the arrangements on the base, and along a longitudinal axis through each of the heat conducting elements.

2. (canceled)

3. The modular heat dissipation assembly according to claim 1, wherein the longitudinal axis of each heat conducting element attached to the base is configured substantially parallel to a main axis of the light emitting device.

4-5. (canceled)

6. The modular heat dissipation assembly according to claim 1, wherein the heat conducting elements are identical in shape.

7. The modular heat dissipation assembly according to claim 1, wherein the heat conducting elements are attached to the base by way of tight-fitting, screwing or soldering.

8. The modular heat dissipation assembly according to claim 1, wherein the base and the heat conducting elements comprise a thermally conductive material.

9. The modular heat dissipation assembly according to claim 1, wherein a central portion of the base is configured for thermally coupling to the light source and/or a driver for the light source, and wherein a rim portion of the base comprises the arrangements.

10. The modular heat dissipation assembly according to claim 9, wherein the arrangements are evenly distributed on the base.

11. A luminaire comprising the modular heat dissipation assembly according to claim 1, wherein the base is thermally coupled to the light source of the light emitting device.

12. The luminaire according to claim 11, wherein the light emitting device comprises a LED or a LED array.

13. A method of manufacturing a modular heat dissipation assembly for a light emitting device, comprising:
providing a plurality of heat conducting elements;
providing a base;
providing arrangements on the base for attaching the heat conducting elements, wherein the arrangements comprise through holes;
determining a thermal load of the light emitting device;
attaching a number of heat conducting elements to the base by inserting the heat conducting elements into the holes of the arrangements, wherein the number varies, so that a thermal capacity of the modular heat dissipation assembly matches the thermal load;
forming the modular heat dissipation assembly with a first aperture, a second aperture and an air channel through the modular heat dissipation assembly,
wherein the air channel is formed through the arrangements on the base and along a longitudinal axis through each of the heat conducting elements.

14. (canceled)

15. The method according to claim 13, wherein the step of attaching a number of heat conducting elements to the base comprises tight-fitting, screwing or soldering.

16. A downlight lamp comprises the modular heat dissipation assembly according to claim 1.
